(19) United States
(12) Patent Application Publication
(10) Pub. No.: US 2005/0114149 A1
(43) Pub. Date: May 26, 2005

(54) Method and apparatus for wireless ordering from a restaurant

(75) Inventors: Herman Rodriguez, Austin, TX (US); Newton James Smith, Austin, TX (US); Clifford Jay Spinac, Austin, TX (US)

Correspondence Address: IBM CORP (YA);C/O YEE & ASSOCIATES PC, P.O. BOX 802333, DALLAS, TX, 75380, US

(73) Assignee: International Business Machines Corporation, Armonk, NY (US)

(21) Appl. No.: 10/718,092

(22) Filed: Nov. 20, 2003

(51) Int. Cl. G06F 17/60

(52) U.S. Cl. 705/1

(57) ABSTRACT

A method, apparatus, and computer instructions for a method for ordering food from a restaurant. A hot spot location is provided for the restaurant. The hot spot provides for wireless communications with a wireless device for a user. In response to detecting the wireless device within the hot spot location, a determination is made as to whether user preferences are stored within the device. The user preferences include charge information and order information. In response to user preferences being present, an order is placed using the order information and the user is charged for the order.

### BACKGROUND OF THE INVENTION

1. Technical Field

The present invention relates generally to an improved data processing system and in particular to a method and apparatus for processing data. Still more particularly, the present invention relates to a method, apparatus, and computer instructions for wireless ordering from a restaurant.

2. Description of Related Art

In today's times, most people eat out at restaurants on a regular basis. In fact, many people go out to eat one or more times each week. When going to popular restaurants, a customer most often waits in line for a table. This wait may vary from a few minutes to a few hours depending on the popularity of the restaurant. In some cases, customers will enter the restaurant, be seated at a table and order food. In other cases, customers may order food from a fast food restaurant, through a drive-through lane, or order food to go from a more traditional sit-down restaurant. This type of ordering usually occurs when a customer is in a hurry and does not have time to sit down and eat in a more traditional restaurant setting.

When ordering food to go or for pickup, the customer may often have to wait longer than desired. For example, the customer first waits in line to place an order and then waits for the order to be prepared. This type of waiting is often a problem when time is limited, such as during lunch time. Further, many customers may order the same food frequently. Currently no mechanism is present for the customer to just say “give me my usual order.” Additionally, with drive-through lanes no convenient method is currently present to pay for an order. A customer typically passes money through a vehicle window to the cashier. Depending on the location of the vehicle and the cashier's window, some customers may have to stretch to reach the window or in some cases, the customer may even have to open the door of the vehicle to pass the money to the cashier. In this exchange, the money may be dropped.

These different drawbacks can make ordering food a time consuming and frustrating experience for a customer. Therefore, it would be advantageous to have an improved method, apparatus, and computer instructions for placing orders for food.

### SUMMARY OF THE INVENTION

The present invention provides a method, apparatus, and computer instructions for a method for ordering food from a restaurant. A hot spot location is provided for the restaurant. The hot spot provides for wireless communications with a wireless device for a user. In response to detecting the wireless device within the hot spot location, a determination is made as to whether user preferences are stored within the device. In response to user preferences being present, a menu is generated based on the user preferences. This menu is sent to the wireless device for use in placing an order.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a network data processing system in which the present invention is implemented;

FIG. 2 is a block diagram of a data processing system that may be implemented as a server in accordance with a preferred embodiment of the present invention;

FIG. 3 is a diagram of a wireless device in the form of a personal digital assistant (PDA) in accordance with a preferred embodiment of the present invention;

FIG. 4 is a diagram illustrating components used in placing orders through wireless hot spot locations in accordance with the preferred embodiment of the present invention;

FIG. 5 is a flowchart of a process for ordering food in a restaurant using a wireless client in accordance with a preferred embodiment of the present invention;

FIG. 6 is a flowchart of a process for ordering food using a wireless client in accordance with a preferred embodiment of the present invention; and

FIG. 7 is a flowchart of a process for generating menus from user preferences in accordance with a preferred embodiment of the present invention.

### DETAILED DESCRIPTION OF THE PREFERRED EMBODIMENT

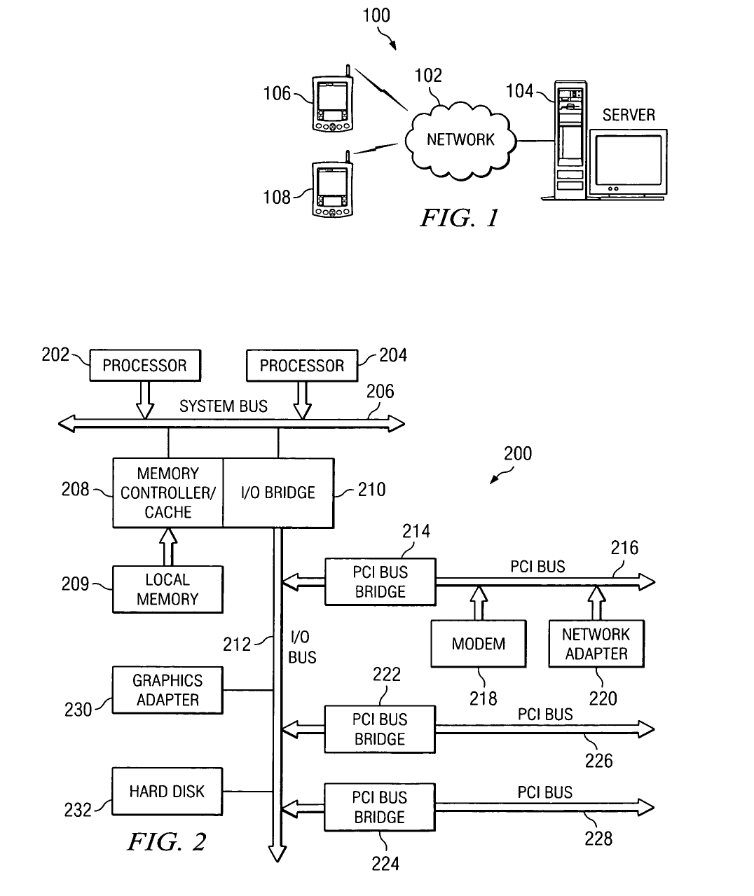

With reference now to the figures and in particular with reference to FIG. 1, a network data processing system is depicted in which the present invention is implemented. Network data processing system 100 includes network 102, which is the medium used to provide communications links between various devices and computers connected together within network data processing system 100. Network 102 may include connections, such as wire, wireless communications links, or fiber optic cable.

In the depicted example, server 104 is connected to network 102. Further, clients 106 and 108 are connected to network 102. In the illustrative example, these two clients are connected through wireless communications links and are wireless devices. In particular, clients 106 and 108 are personal digital assistants (PDA). Server 104 in this example may provide data, such as boot files, operating system images, applications, web pages, and other information to clients 106 and 108. Network data processing system 100 may include additional servers, clients, and other devices not shown. For example, other devices may include routers, switches, or wireless access points to provide for the routing and transmission of data within network 102.

In the depicted example, network data processing system 100 is the Internet with network 102 representing a world wide collection of networks and gateways that use the transmission control protocol/internet protocol (TCP/IP) suite of protocols to communicate with one another. Of course, network data processing system 100 also may be implemented as a number of different types of networks, such as, for example, an intranet, a local area network (LAN), or a wide area network (WAN). Network data processing system 100 in FIG. 1 is intended as an illustrative embodiment and not as an architectural limitation for the present invention.

Within network 102, hot spots may be provided through various wireless access points to generate hot spot locations. In this manner, clients 106 and 108 may access network 102 when they are within a hot spot location. In these examples, a hot spot location is a location in which a wireless device is in proximity to a wireless access point such that communication or exchange of data may be made with that wireless access point. The present invention in the illustrative embodiments allows for orders to be generated through wireless devices, such as clients 106 and 108 when these clients are within selected hot spot locations. These orders may be made through communications with the server, such as server 104, which is used by a business to obtain order information using the mechanism of the present invention in the illustrative embodiments.

Referring to FIG. 2, a block diagram of a data processing system that may be implemented as a server, such as server 104 in FIG. 1, is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI local bus 216. Typical PCI bus implementations will support four PCI expansion slots or add-in connectors. Communications links to clients 106 and 108 in FIG. 1 may be provided through modem 218 and network adapter 220 connected to PCI local bus 216 through add-in connectors.

Additional PCI bus bridges 222 and 224 provide interfaces for additional PCI local buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM eServer pseries system, a product of International Business Machines Corporation in Armonk, New York, running the Advanced Interactive Executive (AIX) operating system or Linux operating system.

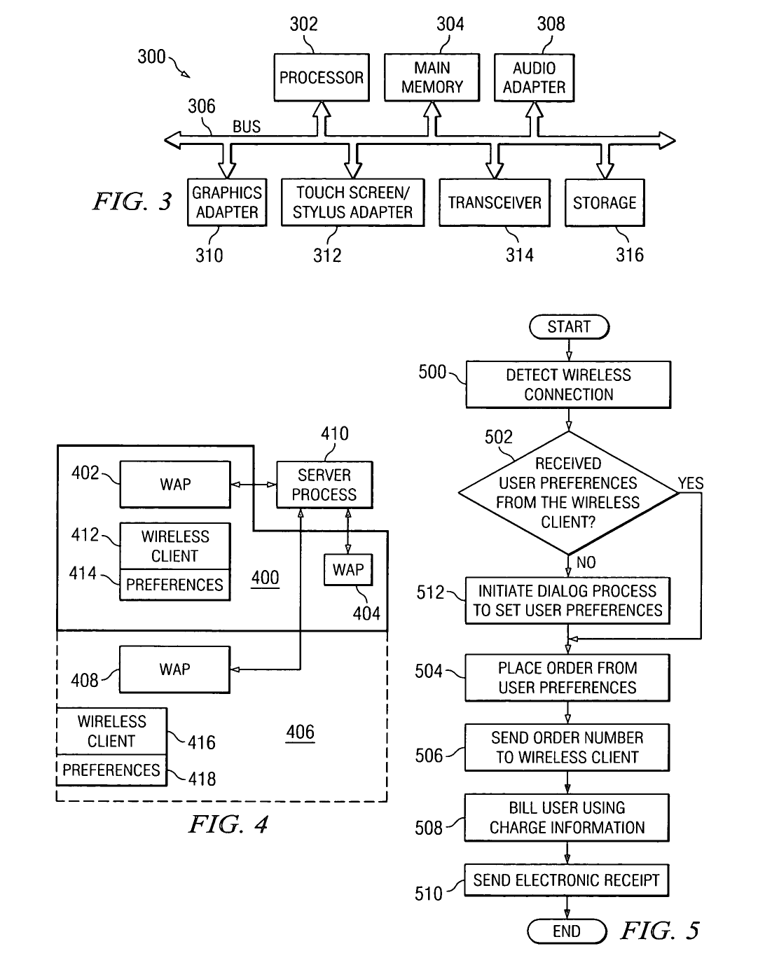

Turning now to FIG. 3, a diagram of a wireless device in the form of a personal digital assistant (PDA) is shown in accordance with a preferred embodiment of the present invention. PDA 300 is an example of a PDA, such as wireless client 106 or wireless client 108 in FIG. 1. PDA 300 includes processor 302 and main memory 304 connected to system bus 306. Further, PDA 300 also includes audio adapter 308, graphics adapter 310, touch screen/stylus adapter 312, transceiver 314, and storage 316 connected to system bus 306.

Audio adapter 308 and graphics adapter 310 provide an interface for the user to hear and see information. Touch screen/stylus adapter 312 allows the user to interact with PDA 300. This particular component allows the user to use a stylus to input data into a touch screen display on PDA 300.

Processor 302 executes instructions stored in main memory 304 to provide the process and function of the present invention. Storage 316 provides for additional storage of data and applications. Storage 316 may take various forms, such as, for example, a flash memory. This flash memory in the illustrative embodiments may be, for example, a Memory Stick, a secured digital (SD) card, a CompactFlash card, or SmartMedia card. Memory Stick is a trademark of Sony Corporation. CompactFlash is a trademark of the CompactFlash association, and SmartMedia is a trademark of Toshiba Corporation. Transceiver 314 provides for sending and receiving data through a wireless communications link.

An operating system runs on processor 302 and is used to coordinate and provide for control of various components within PDA 300 in FIG. 3. The operating system may be, for example, a commercially available operating system, such as Windows Mobile, which is available from Microsoft Corporation. Instructions for the operating system and applications or programs are located on storage 316 in these examples. These instructions may be loaded into main memory 304 for execution by processor 302.

Those of ordinary skill in the art will appreciate that the hardware in FIG. 3 may vary depending on the implementation. Other internal hardware or peripheral devices, such as additional storage in the form of flash read only memory (ROM) or equivalent non-volatile memory may be used in addition to or in place of the hardware illustrated in FIG. 3.

Depending on the particular implementation, other types of wireless devices may be used. For example, a wireless digital phone, laptop computer, or a tablet computer may be used as a client to order food from a business.

Turning next to FIG. 4, a diagram illustrating components used in placing orders through wireless hot spot locations is depicted in accordance with the preferred embodiment of the present invention. In this example, hot spot location 400 is provided through wireless access point (WAP) 402 and wireless access point 404. In this illustrative example, hot spot location 400 is the interior of a restaurant. Another hot spot location, hot spot location 406 is provided outside of the restaurant through wireless access point 408. Hot spot location 406 may be provided for a pick-up or drive-through window for the restaurant. Further, depending on the particular implementation other hot spot locations may be employed. For example, a hot spot location may be placed down the street from the restaurant to allow for ordering before the customer reaches the restaurant. This type of configuration allows for additional time to prepare the order before the customer reaches the pick-up or drive-through window.

These wireless access points are in communication with server process 410. Server process 410 may be executing on a server, such as data processing system 200 in FIG. 2. This server process may be located on the premises of the restaurant or in a remote location, depending on the implementation. These different hot spot locations may be publicized through signs, other literature, or advertising. While a wireless client is in one of these hot spot locations, the user of the device is able to contact only the restaurant in these illustrative examples.

In this example, wireless client 412 is said to be within hot spot location 400 when client 412 is able to establish a communications link with wireless access point 402 or wireless access point 404, which form hot spot location 400 in these examples. In this manner, wireless client 412 is able to exchange data with server process 410. This information may include for example, preferences 414, which are located within wireless client 412.

Wireless client 416 is in hot spot location 406 in this example. In a similar manner, wireless client 416 is able to exchange data with server process 410. In these examples, the data includes preferences 418 stored within wireless client 416.

In these examples, wireless clients 412 and 416 are PDAs, such as PDA 300 in FIG. 3. The preferences stored in these wireless clients include order information and charge information. The order information in preferences 414 and 418 may include preselected orders that a user makes on a regular basis. Alternatively, this order information may be generated by the user in a dialogue with server process 410. In this case, server process 410 may send information, such as a menu to allow the user to generate an order to be stored in the preferences.

Further, preferences 414 and 418 include information that may be used to generate a menu based on the preferences. These preferences may include, for example, dietary needs, language of choice for the menu, and/or monetary requirements. For example, a user may indicate in the preferences that low fat items are desired. Also, the user may have a preference for items that cost less than a certain amount, such as seven dollars. With this preference information, server process 410 may generate a customized menu for a particular user. The preselected orders also may form a basis for generating customized menu options. Further, a history of previously placed orders also may be stored with preferences 414 and 418. This information also may be sent to server process 410 for use in further customizing menu options.

Additionally, the menu may be customized based on the current availability of items. In this manner, menus are dynamically created for different users based on user preferences, such as preferences 414 and 418.

Charge information in preferences 414 and preferences 418 may take various forms. For example, this charge information may include a credit card number, customer name, expiration date for the credit card account, or a frequent diner club account number.

When a user places an order through wireless client 412 or wireless client 416 this order is processed through server process 410. In this illustrative example, a user with wireless client 412 places an order from a table or pick-up counter within the restaurant in hot spot location 400. Another user with wireless client 416 places an order in a pick-up lane outside of the restaurant in hot spot location 406.

After the order has been placed server process 410 returns an order number to the user, depending on the implementation. When the order is ready, the order number may be announced and the user may pick up the order. In some cases, the configuration of the restaurant's ordering process may not require an order number to be returned to the user.

In this example, the user at wireless client 412 receives the order at a table. The user with wireless client 416 drives through the pick-up window to pick up the order.

After the order has been picked up, the user is charged for the food ordered. This billing or charging to the user is performed with the charge information located in preferences 414 and 418. In this manner, the user may be billed without spending time exchanging cash or spending time signing a credit card receipt. Further, this mechanism allows a user to make a “usual order” stored in a set of preferences without having to tell a person at the restaurant each item in the order. Also, the mechanism of the present invention allows for dynamic generation of menus that are customized based on user preferences. This mechanism of the present invention allows for a more efficient ordering system because less manual keying in or writing down of the orders by an employee is required, since the orders are directly entered into the ordering system of the restaurant. Additionally, wait time spent in exchanging cash or signing receipts is avoided.

Further, server process 410 may return a receipt and other information to the wireless client in an electronic form. Charge information may be placed in a form for use by an expense account program or a financial management program. In this manner, a user may receive information for use in obtaining reimbursements or for budgeting purposes. Additionally, information about the items ordered may be placed in a format for use by a meal planning program. This information may include, for example, the number of calories for each item, the number of grams of fat for each item, the number of grams of carbohydrates for each item, as well as other nutritional information.

Turning now to FIG. 5, a flowchart of a process for ordering food in a restaurant using a wireless client is depicted in accordance with a preferred embodiment of the present invention. The process illustrated in FIG. 5 may be implemented in a server process such as server process 410 in FIG. 4.

The process begins by detecting a wireless connection (step 500). The wireless connection occurs when the wireless device is within proximity of a hot spot, such that a communications link may be established with the hot spot.

Thereafter, a determination is made as to whether user preferences are received from the wireless client (step 502). A receipt of these preferences indicates that the user is ready to place an order in these illustrative examples. If the user preferences are received from the wireless client, an order is then placed for the user from the user preferences (step 504). An order number is sent to the wireless client (step 506).

Thereafter, the user is billed using the charge information in the user preferences (step 508). Then an electronic receipt is returned to the wireless client (step 510) with the process terminating thereafter. Additionally, other information, such as nutritional information may be returned with the receipt in step 510.

With reference again to step 502, if user preferences are not received from the wireless client, it is assumed that the user needs information to place an order. As a result, a dialogue process is initiated to set the user preferences (step 512). This dialogue may include, for example, sending menu information to the wireless client to allow the user to select items for order information to set the user preferences.

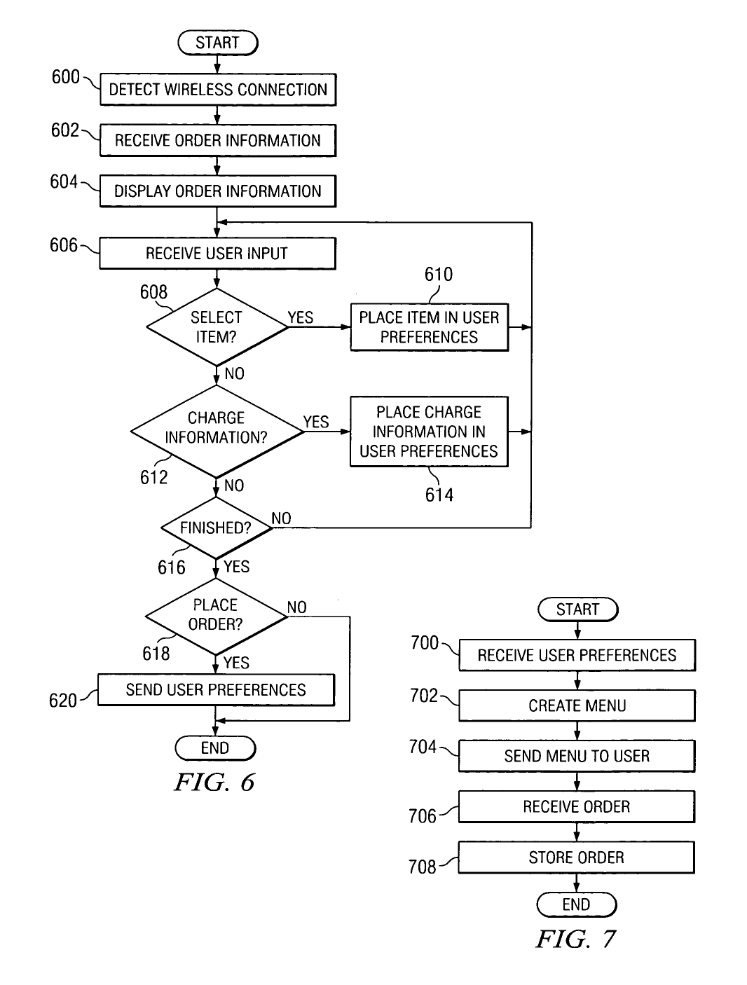

Turning next to FIG. 6, a flowchart of a process for ordering food using a wireless client is depicted in accordance with a preferred embodiment of the present invention. The process illustrated in FIG. 6 may be implemented in a wireless client, such as wireless client 412 in FIG. 4.

The process begins by detecting a wireless connection (step 600). The wireless connection occurs when the wireless client is in a hot spot location and the user initiates contact with the hot spot. Order information is received (step 602). This order information is received as part of a dialogue process to set user preferences. This order information may include a set of menus to select items to be ordered. This order information is displayed to the user on the wireless client (step 604).

Thereafter, user input is received (step 606). Next, a determination is made as to whether the user input selects an item from the order information (step 608). If the user input selects an item, this item is placed into the user preferences (step 610) with the process then returning to step 606.

With reference again to step 608, if the user input does not select an item, a determination is made as to whether the user input enters or includes charge information (step 612). If the user input enters or includes charge information, this charge information is placed in the user preferences (step 614) with the process returning to step 606 as described above. Otherwise, a determination is made as to whether the user input indicates whether the user has finished setting preferences (step 616). If the user input does not indicate that the user has finished, the process returns to step 606.

Otherwise, a determination is made as to whether to place an order (step 618). If the order is to be placed, the user preferences are sent to the server process for the restaurant (step 620) with the process terminating thereafter. On the other hand, if an order is not to be placed, the process terminates without sending the user preferences.

This process also may be used to send a set of previously stored user preferences for a order regularly made by the user. In this case, the user input in step 606 would indicate that the user is finished and then the order from the user preferences and the charge information stored in the wireless client are sent to server process 410 in FIG. 4.

Turning now to FIG. 7, a flowchart of a process for generating menus from user preferences is depicted in accordance with a preferred embodiment of the present invention. The process illustrated in FIG. 7 may be implemented in a server process, such as server process 410 in FIG. 4.

The process begins by receiving user preferences (step 700). These preferences may be received from a client, such as wireless client 412 in FIG. 4. These preferences are used to dynamically create a menu (step 702). The menu created in step 702 is customized for the user based on the preferences. For example, a customer may have a preference for low fat items or for daily specials. Further, the menu also is customized based on the current availability of items at the establishment. The customized menu is then sent to the user at the wireless client (step 704). Order information is then received (step 706). This order information is then stored (step 708) with the process terminating thereafter. This stored order information is then used to fill the order made by the user.

Thus, the present invention provides a method, apparatus, and computer instructions for ordering food from a restaurant using a wireless client. The mechanism of the present invention allows for order and charge information to be sent to a restaurant from a wireless client to place an order with the restaurant. This information is used to generate the order and charge the client for the food. Also, user preferences are used to dynamically generate a customized menu that is sent to the user at the wireless client. This mechanism also allows for ordering of food with less time than that required for an order taken manually by an employee of the restaurant. Further, the transfer of cash is not required, so that the same amount of work may be performed with fewer employees.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of encoded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

1. A method for ordering food from a restaurant, the method comprising:
providing a hot spot location for the restaurant, wherein the hot spot provides for wireless communications with a wireless device for a user;
responsive to detecting the wireless device within the hot spot location, determining whether user preferences are stored within the wireless device;
responsive to user preferences being present, dynamically generating a menu based on the user preferences, wherein the menu is customized by a server process associated with the restaurant; and
sending the menu to the wireless device, wherein an order is placed through the wireless device using the menu.

2. The method of claim 1 further comprising:
charging the user for the order.

3. The method of claim 1, wherein the menu also is based on availability of items at the restaurant.

4. The method of claim 1 further comprising:
responsive to placement of the order, sending an order identification to the wireless device.

5. The method of claim 1, wherein the hot spot location is located within the restaurant.

6. The method of claim 1, wherein the hot spot location is located outside of the restaurant in a drive-through area of the restaurant or a location away from a premises of the restaurant.

7. The method of claim 1 further comprising:
responsive to user preferences not being present, entering into an electronic dialog between the server process associated with the restaurant and the user to place the order.

8. The method of claim 1, wherein the wireless device is one of a personal digital assistant, a notebook computer, or a digital wireless phone.

9. The method of claim 1, wherein the user preferences include charge information, including at least one of credit card information and frequent diner club information.

10. The method of claim 9 further comprising:
sending receipt information to the wireless device for use in at least one of a personal expense program and a financial management program.

11. The method of claim 1 further comprising:
sending order information for use by a food analysis program on the wireless device.

12. The method of claim 1, wherein the user preferences include at least one of dietary needs, language of choice for the menu, and monetary preferences.

13. A data processing system for ordering food from a restaurant, the data processing system comprising:
providing means for providing a hot spot location for the restaurant, wherein the hot spot provides for wireless communications with a wireless device for a user;
determining means, responsive to detecting the wireless device within the hot spot location, for determining whether user preferences are stored within the wireless device;
generating means, responsive to user preferences being present, for dynamically generating a menu based on the user preferences, wherein the menu is customized by a server process associated with the restaurant; and
sending means for sending the menu to the wireless device, wherein an order is placed through the wireless device using the menu.

14. The data processing system of claim 13 farther comprising:
charging means for charging the user for the order.

15. The data processing system of claim 13 further comprising:
sending means, responsive to placement of the order, for sending an order identification to the wireless device.

16. The data processing system of claim 13, wherein the hot spot location is located within the restaurant.

17. The data processing system of claim 13, wherein the hot spot location is located outside of the restaurant in a drive-through area of the restaurant or at a location away from a premises of the restaurant.

18. The data processing system of claim 13 further comprising:
entering means, responsive to user preferences not being present, entering into an electronic dialog between the server process associated with the restaurant and the user to place the order.

19. The data processing system of claim 13, wherein the wireless device is one of a personal digital, assistant, a notebook computer, or a digital wireless phone.

20. A data processing system comprising:
a bus system;
a memory connected to the bus system, wherein the memory includes a set of instructions; and
a processing unit connected to the bus system, wherein the processing unit executes the set of instructions to provide a hot spot location for the restaurant, wherein the hot spot location provides for wireless communications with a wireless device for a user; to determine whether user preferences arc stored within the wireless device in response to detecting the wireless device within the hot spot location; to dynamically generate a menu based on the user preferences, wherein the menu is customized by a server process associated with the restaurant; and to send the menu to the wireless device, wherein an order is placed through the wireless device using the menu.

21. A computer program product in a computer readable medium for ordering food from a restaurant, the computer program product comprising:
first instructions for providing a hot spot location for the restaurant, wherein the hot spot provides for wireless communications with a wireless device for a user;
second instructions, responsive to detecting the wireless device within the hot spot location, for determining whether user preferences are stored within the wireless device;
third instructions, responsive to user preferences being present, for dynamically generating a menu based on the user preferences, wherein the menu is customized by a server process associated with the restaurant; and
fourth instructions for sending the menu to the wireless device, wherein an order is placed through the wireless device using the menu.

22. The computer program product of claim 21 further comprising:
fifth instructions, responsive to placement of the order, for sending an order identification to the wireless device.

23. The computer program product of claim 21, wherein the hot spot location is located within the restaurant.

24. The computer program product of claim 21, wherein the hot spot location is located outside of the restaurant in a drive-trough area of the restaurant or away from a premises of the restaurant.

25. The computer program product of claim 21 further comprising:
fifth instructions, responsive to user preferences not being present, entering into an electronic dialog between the server process associated with the restaurant and the user to place the order.
